(19) United States
(12) Patent Application Publication
(10) Pub. No.: US 2002/0164410 A1
(43) Pub. Date: Nov. 7, 2002

(54) Method and apparatus to produce coffee extract

(76) Inventors: Ralph R. Ogden, Highland, IN (US); Heikki Huik, Schererville, IN (US)

Correspondence Address: PATULA & ASSOCIATES, PC, 116 SOUTH MICHIGAN AVENUE, 14TH FLOOR, CHICAGO, IL, 60603, US

(21) Appl. No.: 09/849,161

(22) Filed: May 4, 2001

(51) Int. Cl. A23L 1/00

(52) U.S. Cl. 426/506

(57) ABSTRACT

A method and apparatus producing high-quality coffee extract is disclosed. The apparatus contains a base module, extraction chamber and an extract holding chamber. The base module contains a pumping means that recirculates the extract liquid within the extract chamber to ensure efficient and thorough extraction. When extraction is complete, the pumping means will pump the extract liquid into an extract holding chamber where it can be detached from the extraction module and placed wherever desired. The liquid extract can be dispensed whenever needed and will have an extended shelf life.

### TECHNICAL FIELD

The invention relates generally to and apparatus for and process of producing an extract from a granular solid substance by processing with a liquid based solvent suspension or solution. More particularly, the invention relates to a method and apparatus for the production of coffee extract for the creation of beverages or foods additives.

### BACKGROUND OF THE INVENTION

There has long been a desire in the coffee extract production field to allow consumers to create their own high-quality coffee extract. The most common need of coffee extract is in the creation of coffee beverages and preparation of certain foods. For example, if a consumer wants a quick coffee drink, the typical purchase is “instant-coffee”, a pre-packaged, solidified coffee extract that, when added to normal hot water, produces a lower-quality coffee beverage. Common complaints of such a product are attributable to unpleasant taste and odor. It is well known in the field that existing coffee extract techniques lose some of their inherent aromas that are associated with taste and odor. Furthermore, there are some food preparation recipes, such as for home baked goods, that require the addition of coffee extract. This is usually accomplished with the purchase of pre-packaged liquid coffee extract. This is expensive and the quality of the product is always in question because of the unknown extraction method and shelf life of the product.

Currently, there are no known devices that would allow consumers to create their own liquid coffee extract, due to the lack of efficient extraction devices and usability knowledge. There are some very inefficient cold brew coffee extract devices available, but the extract-to-coffee ratio is very low, and as such, their usability is extremely limited and inefficient. Furthermore, the extracted coffee has a very short shelf life due to environmental contamination and aromatic dissipation.

U.S. Pat. No. 3,593,650 issued to Martin, et. al., issued on Jul. 20, 1971, teaches the ability of using concentrated coffee extract to produce brewed coffee. However, the Martin et. al. patent is not readily adaptable to consumer or small commercial use, nor does it provide the ability to store coffee extract for future dispensing. Furthermore, the Martin et. al. patent presents a complexity of parts and components, which must function in unison to brew large quantities of coffee.

U.S. Pat. No. 4,534,985 issued to Gasau on Aug. 13, 1985, teaches the ability of using a continuous extraction process wherein a continuous supply of fresh ground coffee is introduced into a closed system whereby extraction occurs. However, the Gasau process must use a pressurized extraction liquid, which must be maintained at predetermined pressures. Lastly, the Gasau process does not provide quick and readily available coffee extract and, as such, is not suitable for smaller implementation.

U.S. Pat. No. 6,119,582 issued Akkerman-Theunisse et. al. issued on Sep. 19, 2000, teaches the ability of producing liquid coffee extract by maintaining a pressurized outlet of extract coffee dispensing in a reservoir area. The Akkerman-Theunisse et. al. patent creates coffee extract using a Neopolitana apparatus comprising a filling chamber used for the formation of coffee extract and coffee extract bubbled foam created from the pressurized outlet. However, the invention is not practical for small operations and does not economically produce readily accessible coffee extract.

The present invention fulfills the need in the field of beverage preparation and consumption, more particularly, in the production of coffee extract for beverage and food preparation uses. The apparatus allows an ordinary home user or commercial establishment to quickly and easily create a high-quality coffee extract. The apparatus can be utilized by anyone with a basic knowledge of kitchen and food preparation appliances and utensils.

### OBJECTS OF THE INVENTION

An object of the presently claimed invention is to quickly and efficiently produce fresh liquid coffee extract that will have an extended shelf life. This enables the user to more efficiently utilize roast and ground coffee because the extraction method utilizes less roast and ground coffee compared to conventional coffee production techniques. For example, it is estimated that the cost savings are attributed to about 10-15% more cups of finished beverage per pound of coffee compared to conventional coffee brewing techniques.

The present invention is intended to allow the user to create a high-quality liquid coffee extract that allows the user to save such extract for weeks at a time, thus allowing the user to create a high-quality cup of coffee quickly whenever desired. This is accomplished by using a desired amount of liquid coffee extract, based upon the user's desired coffee strength and taste preferences, and mixing with normal hot or cold water. This new coffee extract is available at anytime to the user, similar to conventional instant coffee production, but with a significantly higher quality and lower cost.

Numerous other objects, features and advantages of the present invention will become readily apparent through the detailed description of the preferred embodiment, drawings and the claims.

### SUMMARY OF THE INVENTION

The present apparatus is comprised of three, detachable sections. The first section is the base module unit. This unit maintains the proper foundational support for the other two modules, in conjunction with housing the pumping unit, timer, inlet and outlet hoses and any required electrical wiring. The base unit has an appropriate amount of ventilation holes in order to maintain proper ventilation for the pumping unit and timer. Furthermore, the base unit provides a connecting aperture for the extraction module.

The second section consists of the extraction module, wherein the coffee grounds are placed and the actual extraction process occurs. An outlet aperture on the extraction module allows processed coffee extract to be withdrawn from the module. An inlet aperture allows recirculated extraction liquid to be replaced into the extraction unit. The components of the extraction module include a removable bottom diffusion plate that rests on the bottom of the extraction module and ensures that the vacuum of the pump is pulling the coffee extract during the coffee extraction process. Placed on top of the diffuser plate top is a filter unit. A top diffuser plate ensures proper water flow and distribution during the extraction process.

The extraction module serves as the mating location for a liquid extract holding chamber. The extract holding chamber has a spout located at the lowest location of the extract holding chamber. The extract holding chamber is used to maintain the freshness of the coffee extract subsequent to the extraction process. This is accomplished by using the base module's pumping unit to pump the finished extract from the extraction module into the extract holding chamber. Extract freshness is ensured by either using a self-collapsible bladder located within the extract holding chamber that actually holds the extract, using a closed cell float that maintains a constant seal against the inside walls of the extract holding chamber, or using a sealable lid for the top of the extract holding chamber.

It is intended that the present invention is easy to use. When coffee extract production is desired, the user places a predetermined amount of fresh, ground coffee beans on top of the filter unit located within the extraction module. The users then connects the extraction module's outlet aperture to the input of the pumping unit followed by the connection of the extraction module's inlet aperture to the output of the pumping unit. This will enable the extraction process to have a constant supply of recirculated liquid extract, thus increasing extraction efficiency. The user then replaces the top diffuser plate and adds fresh hot, preferably boiling, water. The user then attaches the extract holding chamber to the top of the extraction module ensuring an airtight seal. The user then selects a predetermined time limit on the base module timer, thus activating the pumping unit, which in turn circulates the liquid extraction within the extraction module.

When the timer has completed the cycle time selected, it automatically shuts off the pumping unit. The user then disconnects the module's inlet aperture and connects the pumping unit output to the extract holding chamber's inlet aperture. The user then selects a predetermined time on the timer and the pumping unit pumps the completed liquid extract from the extraction module into the extract holding chamber.

### DESCRIPTION OF THE DRAWINGS

A preferred embodiment of the present apparatus is described herein with reference to the drawings wherein:

FIG. 1 is a perspective view of the present invention as assembled;

FIG. 2 is a partially exploded perspective view of the base module of the present invention;

FIG. 3 is a partially exploded perspective view of the extraction chamber of the present invention;

FIG. 4 is a partially exploded cross-section view of the extraction chamber of the present invention;

FIG. 5 is a partially exploded perspective view of the extract holding chamber of the present invention;

FIG. 6 is an enlarged cross-sectional view of the spout assembly of the present invention; and

FIG. 7 is a perspective view of a method of mounting the extract holding chamber under conventional kitchen cabinets.

### DETAILED DESCRIPTION OF THE PREFERRED EMBODIMENT

While the invention is susceptible of embodiment in many different forms, there will be described herein in detail, preferred and alternate embodiments of the present invention. It should be understood, however, that the present disclosure is to be considered an exemplification of the principles of the invention and is not intended to limit the spirit and scope of the invention and/or claims of the embodiments illustrated.

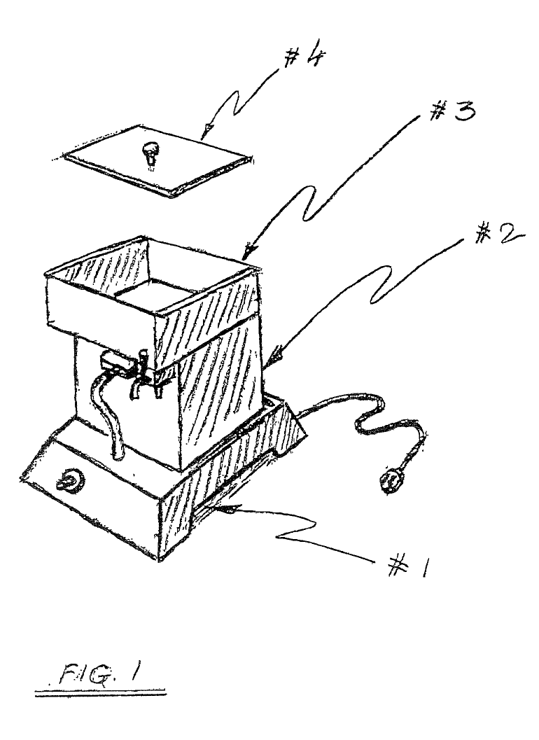

Referring to FIGS. 1-7, a preferred embodiment of the present apparatus is shown as a liquid extraction device. The preferred embodiment of the present invention is for the liquid extraction of ground coffee, however, the apparatus can be used for the liquid extraction of many different materials, such as tea, flowers, spices, and the like. Referring to FIG. 1, the preferred embodiment entails individual, detachable modules, which includes a supporting base module 1, a coffee extraction chamber 2, and an extract holding chamber 3. It should be understood, however, that the apparatus could be formed as a single unit. Each individual module can be constructed of a corrosion resistant material, preferably, plastic, stainless steel or painted metallic material, however, the preferred embodiment of the present invention is constructed of materials complying with ANSI/NSF Standard 51. Since each module is not material dependent upon another, each can be made of a different material, although it is preferable that each module be made of the same material. An optional closing lid 4 can be utilized to seal the unit when it is not in use.

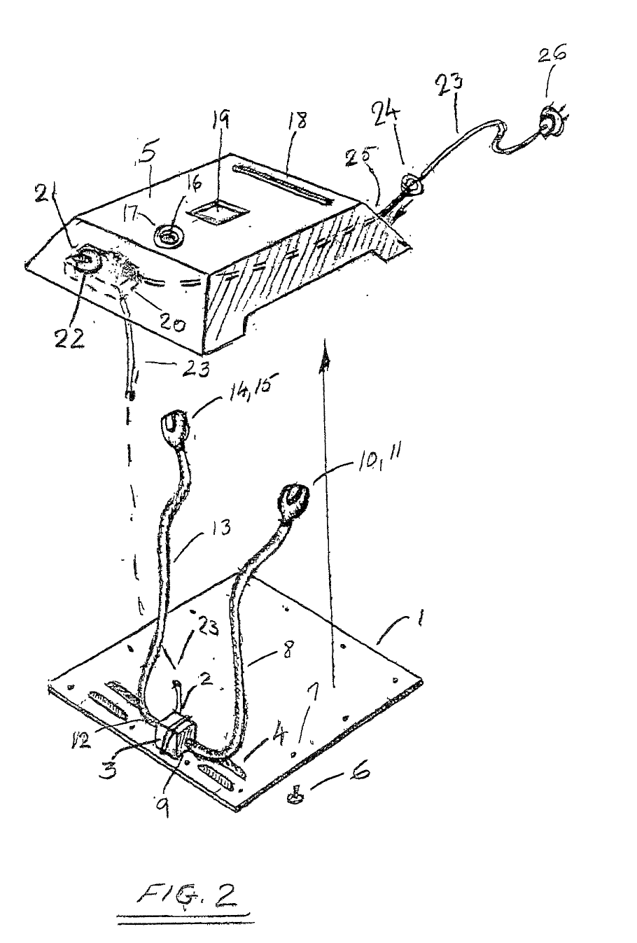

Referring to FIG. 2, the base module consists of two primary housing components; a flat, horizontal base plate 1 and a covering module 5. The flat horizontal plate 1 has at least one suitably located ventilation aperture 4 that is used to ensure proper heat dissipation during the unit's operation.

Within the base module is further contained a pumping means 2 fixedly attached to the flat horizontal base plate 1 via a plastic strap 3 or any other suitable mounting means. The pumping means 2 has an inlet port 9 and an outlet port 12 for pumping operations. Attached to the inlet port 9 is a flexible hose 8 terminated with either the male or female connection of a quick-disconnect termination 10 (female connection shown). Within the male or female quick-disconnect termination 10 is an internal check valve (not shown) to control undesired backflow during the operation of the apparatus. Attached to the outlet port 12 is a flexible hose 13 terminated with either the male or female connection of a quick-disconnect termination 14 (female connection shown). Within the male or female quick-disconnect termination 14 is an internal check valve (not shown).

In the preferred embodiment, the pumping means 2 is further connected in electrical series to a timer 21, fixedly attached to the covering module 5, to control the extraction process. An alternate embodiment of the present invention uses a manual switching means to control the extraction process. On the outside of the covering module 5 surrounding a knob stem of the timer 21 is a time cover plate 22 with conventional time demarcations in 1-minute intervals or other intervals.

Within the covering module 5 is an aperture 16 that has an inside diameter slightly larger than the outside diameter of the inlet hose 13. Around the perimeter of aperture 16 is a rubberized grommet 17 that will ensure that when the outlet hose 13 is inserted through aperture 16, the outlet hose 13 will not be chaffed or damaged. In order for the unit to be assembled, the quick-disconnect mechanism 14 on outlet hose 13 must be attached to the outlet hose 13 after outlet hose 13 is inserted through aperture 16.

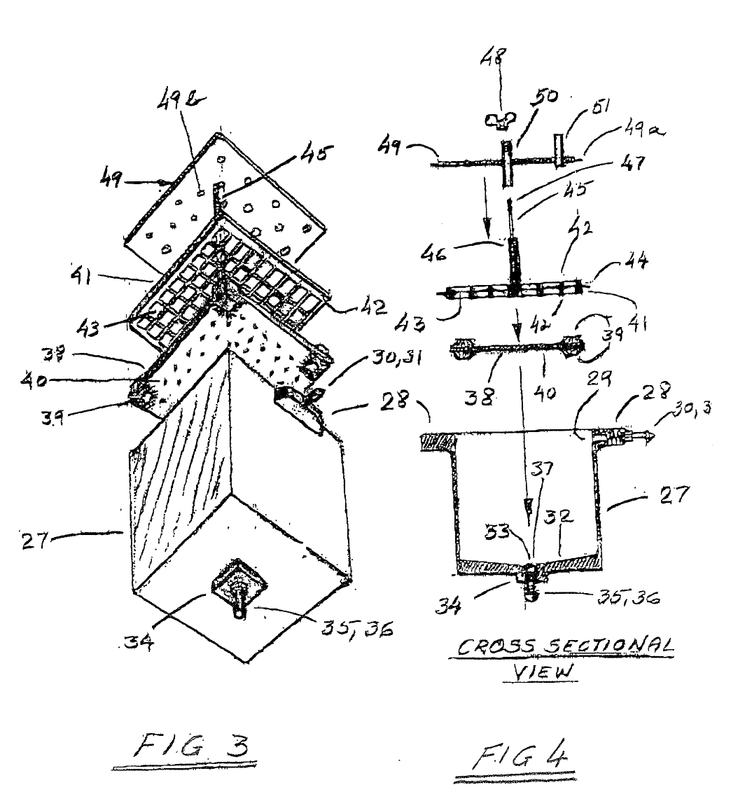

Furthermore, on the covering module 5 there is at least one ventilation aperture 18 to ensure adequate heat dissipation during operation. There is also a connection aperture 19 for mounting the extraction chamber 27 and it is shaped and sized to receive the protruding connection 34 of the extraction chamber 27 shown in FIG. 3. On the opposite side of the timer is an aperture for the electrical connection 25 that can be connected into a conventional electric wall socket (not shown) via the plug 26.

Referring to FIGS. 3 and 4, the extraction chamber 27 is the unit responsible for the actual extraction of liquid coffee extract. The preferred embodiment of the extraction chamber 27 can be any shape and size, but preferably is square, rectangular or circular in shape. The inside bottom portion 32 of the extraction chamber 27 is sloped to create a low point 33 within the extraction chamber 27. This low point 33 has an aperture, with a filter element (not shown), in which is attached the complimentary quick-disconnect termination 35 (male shown) for the inlet hose female termination 10 in FIG. 2. Furthermore, the quick-disconnect termination 35 has an internal check valve (not shown) that prevents any flow of extract when the male and female segments are separated. It is obvious that different hoses, connection mechanisms, and valving can be substituted for hoses with quick disconnect fittings with internal check valves.

Beneath the low point 33 is an external protruding section 34 having the same shape and size as the connecting aperture 19 of the base cover module 5 (FIG. 2). When assembled, the protruding section 34 fits into the connecting aperture 19 (FIG. 2) thus mounting the extraction module 27 to the base module.

At the top of the extraction chamber 27 are multiple formed handles 28 for ease of manual transport. Within one of these formed handles 28 is an inlet aperture 29 attached to the opposite end of the quick-disconnect termination 30 (male shown) of the outlet hose termination 10 (FIG. 2). It should be understood that the inlet aperture can be formed apart from a handle.

Still referring to FIGS. 3 and 4, the preferred embodiment of the present invention contains within the inside of the extraction module a bottom diffuser plate 38. The bottom diffuser plate has multiple apertures 40 preferably with a cumulative aperture surface area equal to the surface area of the outlet aperture at low point 33. The bottom diffuser plate 38 has small footings 39 on both the bottom and top of the diffuser plate 38 located around the perimeter. The footings 39 on the bottom of the diffuser plate 38 ensure a minimal separation distance between the bottom 40 of the diffuser plate 38 and the bottom 32 of the extraction chamber 27. The footings 39 on the top of the diffuser plate 38 ensure a separation distance between the bottom diffuser plate 38 and a filter unit 41. The perimeter of the bottom diffuser plate 38 will be slightly less than the inside perimeter of the extraction chamber 27.

Placed on top of the bottom diffuser plate 38 is the filter unit 41. The filter unit 41 comprises a bottom grid plate 43, a filter medium 44, a top grid plate 42 and a stepped stem having lower portion 46 and upper portion 45. The top 47 of the stepped stem upper portion 45 is threaded. The filter medium 44 can be any type of material that maintains a suitable sieve size no greater than typical coffee grounds. The preferred embodiment has a filter medium 44 located at low point 33 to ensure that coffee grounds do not affect the performance of lower aperture. Around the perimeter of the filter medium 44 is a resilient gasket. The perimeter of the filter medium 44 is slightly greater than the inside perimeter of the extraction chamber 27 to ensure that when the filter unit is placed inside of the extraction chamber 27, the filter medium 44 creates a tight seal against the inside walls of the extraction chamber 27.

Placed on top of the filter unit 41 is a top diffuser plate 49. The top diffuser plate 49 has multiple apertures 49b with a cumulative surface area preferably equal to the cumulative surface area of the bottom diffuser plate 38. The top diffuser plate 49 also has an air release aperture or vent tube 51 intended to control the possibility of contaminant air pocket build-up within the extraction chamber 27 during apparatus operation. The perimeter of the top diffuser plate 49 is attached to a resilient material seal 49a. The perimeter of the top diffuser plate 49 is slightly less than the inside perimeter of the extraction chamber 27 to ensure that when the top diffuser plate 49 is inserted into the extraction chamber 27, the resilient material 49a creates an air tight seal. Within the center of the diffuser plate 49 is an aperture or spacer tube 50 with a diameter slightly larger than the diameter of the stepped stem upper portion 45. The stepped stem upper portion 45 is inserted into the spacer tube 50. The stem acts as a stop when the tube 50 of top diffuser plate 49 reaches the top of the stepped stem lower portion 46. This ensures a consistent distance between the top diffuser plate 49 and the coffee (not shown) placed on top of the filter unit 41 during apparatus operation as described below. When the extraction chamber 27 is assembled, a wing nut 48 with an aperture and thread count equal to the diameter and thread count of the top 47 of stepped stem upper portion 45 is tightened during operation.

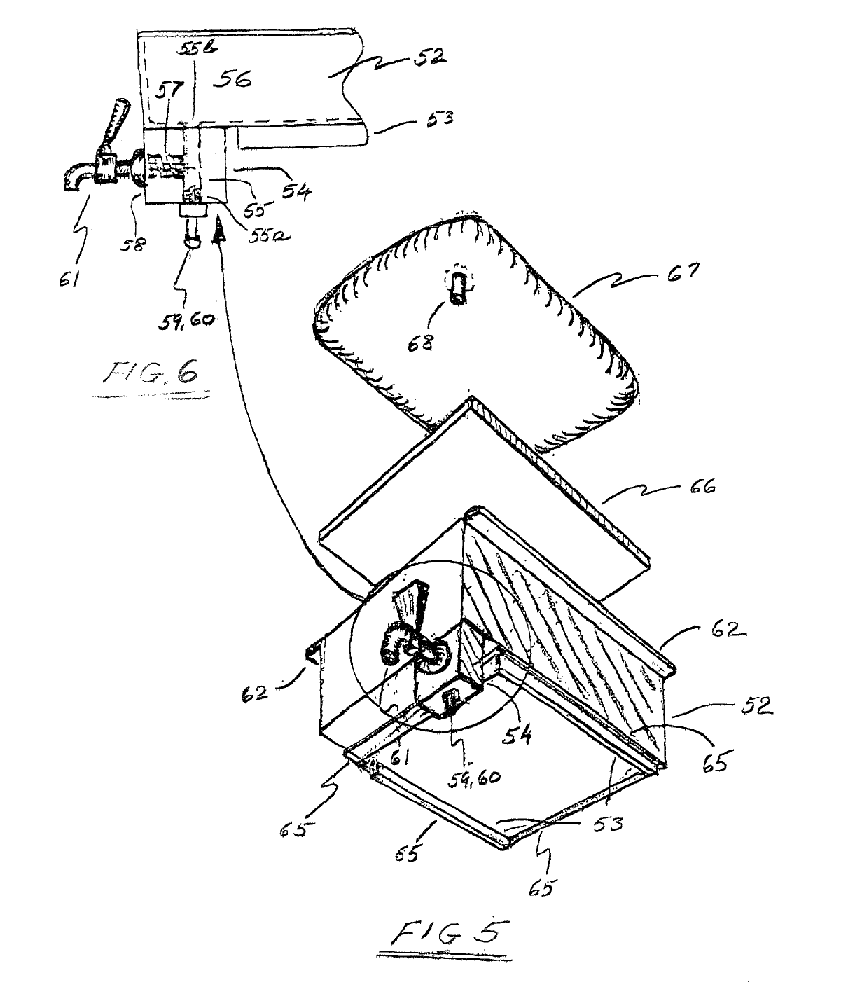

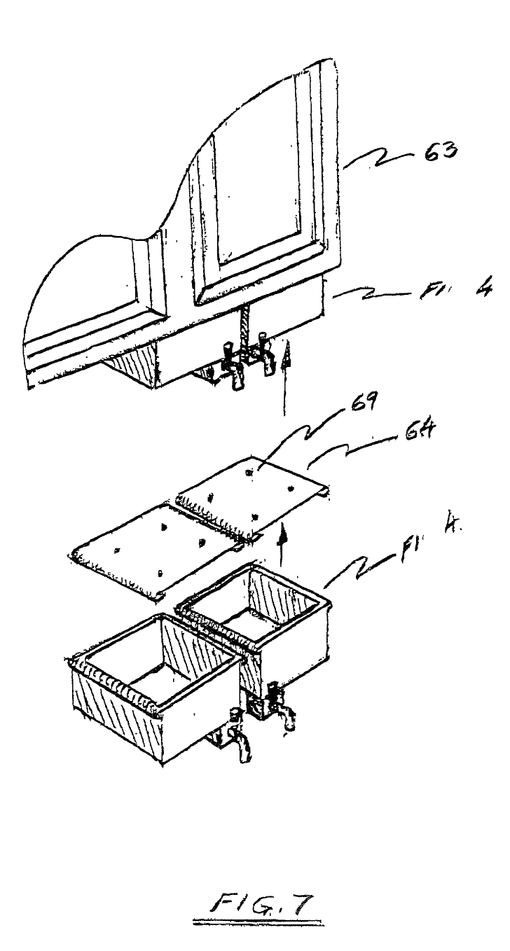

Referring to FIGS. 5 and 6, the extract holding chamber 52 has a bottom lip 65 which will be lined with a resilient seal material 53. When the extract holding chamber 52 is attached to the top of the extraction module 27 (FIG. 1) the bottom lip 65 fits snuggly into the top of the extraction module 27, creating an airtight seal with the resilient seal material 53. Around the outside top perimeter of the extract holding chamber 52 is molded rims 62 for mounting to a cabinet or other surface as described with respect to FIG. 7.

Within the preferred embodiment of the apparatus, the inside of the extract holding chamber 52 is lined with a self-collapsible bladder 67 with a protruding stem 68. However, a closed float cell 66 with the same perimeter as the inside of the extract holding chamber 52 or a self-sealable lid 4 (FIG. 1) are also contemplated for creating an air-tight environment for the stored coffee extract (not shown).

A faucet housing 58 attaches to the extract holding chamber 52. Operatively mounted in faucet housing 58 is a self-closing spout or faucet 61. Extending through faucet housing 58 is an aperture 55 into which stem 68 is placed to supply extract to the faucet 61. A quick-disconnect termination 59 (male shown) having an internal check valve 60 is provided at the bottom of aperture 55 to connect to the quick-disconnect termination 14 of outlet hose 13 to fill bladder 67.

FIG. 7 illustrates a means for mounting the extract holding chamber 52 under conventional kitchen cabinets 63. Mounting plates 64 are fixedly attached to the underside of kitchen cabinets 63 wherein the mounting brackets receive the rim portion 62 of the extract holding chamber 52. It should be noted, however, that such a means of mounting is one alternate of many that can be utilized to store the extract holding chamber 52.

Operation of the unit commences when the unit is assembled together as shown in FIGS. 1-6. The user places a predetermined amount of fresh ground coffee beans onto the filter unit 41. The top diffuser plate 49 is then securely attached via the wing nut 48 being threaded onto the filter unit stem upper portion 45. The quick-disconnect termination 10 of the inlet flexible hose 8 is connected to the quick-disconnect termination 35 of the outlet aperture 33 of the extraction chamber 27. The quick-disconnect termination 10 of the outlet flexible hose 13 is attached to the inlet quick-disconnect termination 30. The user then adds a predetermined amount of hot water into the extraction chamber 27. The preferred embodiment is a 5:1 water-to-coffee ratio. However, this can be adjusted based upon the user's desired needs and taste. The extract holding chamber 52 is then placed onto the top of the extraction chamber 27 creating an airtight seal with the resilient seal 53. The user then sets a predetermined amount of time on the timer 21. The preferred embodiment is twenty minutes but this can be adjusted based upon the user's desired needs and taste. The pumping unit 2 will begin to circulate the extraction water in the extraction chamber 27. When the timer 21 has completed its cycle, it will automatically shut off the pumping unit 2. The user then disconnects the outlet hose 13 quick-disconnection termination 14 from the quick-disconnection termination 30 of the inlet aperture 29. The user then connects the outlet hose 13 quick-disconnection termination 14 to the quick-disconnect termination 59 of the inlet aperture 55. The user once again sets a predetermined amount of time on the timer 21 and the pumping unit 2 will withdraw the liquid extract from the extraction chamber 27 via the outlet aperture quick-disconnection termination 35 and pump the extract liquid into the extract holding chamber 52. The extract liquid can be delivered into a self-collapsible bladder 67 to ensure extract freshness. If bladder 67 is not used, the extract liquid can be placed directly into the extract holding chamber 52 wherein a closed cell float 66 or a self-sealing lid 4 will ensure extract freshness. When the pumping cycle is complete, the user can remove the extract holding chamber 52 from the extraction chamber 27 and slide the extract holding chamber 52 into mounts 64 attached to a kitchen cabinet 63 or other structure.

If the user of the present invention described herein follows the preferred process, he/she will be able to successfully produce a coffee extract that constitutes a coffee beverage that is as flavorful and robust as brewed coffee produced by a conventional brewing apparatus using a comparable grade of roast and ground coffee. This is due to the present invention's ability to create extract while maintaining very minimal contact with atmospheric oxygen, which deprives the coffee of flavor and quality longevity. The preferred embodiment includes using water that has been boiled previous to being used within the extraction phase. The boiling action removes a majority of the dissolved oxygen from within the water. During the extraction process within the present invention, the only source of contact with atmospheric oxygen is the air gap below the lid covering the extraction chamber and above the extract. This gap includes an inconsequential amount of atmospheric oxygen, and thus does not degrade the produced extract's quality. The storage means also maintains an airtight environment, thus essentially eliminating extract contamination with atmospheric oxygen until such extract is dispensed from the storage means and is used within beverage production or other purposes.

The foregoing specification describes only the preferred embodiment of the invention as shown. Other embodiments besides the above may be articulated as well. The terms and expressions therefore serve only to describe the invention by example only and not to limit the invention. It is expected that others will perceive differences, which while differing from the foregoing, do not depart from the spirit and scope of the invention herein described and claimed.

What is claimed is:

1. A liquid extraction apparatus comprising, in combination:
a means for conducting an extract process wherein said completed extract is held in a means for holding and storing; and
a means for controlling an extraction process.

2. A liquid extraction apparatus as claimed in claim 1 wherein said means for controlling an extraction process comprises:
a base module having a rigid horizontal plate;
a means for pumping liquid; and
a base covering module fixedly attached to said rigid horizontal plate.

3. A liquid extraction apparatus as claimed in claim 2 wherein said means for pumping liquid comprises:
an inlet connection and an outlet connection;
a means of controlling said pump;
a flexible inlet hose fixedly attached to said inlet connection;
a flexible outlet hose fixedly attached to said outlet connection;
said flexible inlet hose and said flexible outlet hose are terminated with a quick disconnect piping connection terminal;
said quick disconnect piping connection terminal is either a female or a male connection; and
said quick disconnect piping connection terminal contains an internal check valve.

4. A liquid extraction apparatus as claimed in claim 1 wherein said means for conducting an extract process comprises:
an extraction chamber having a top portion and a bottom portion;
said extraction chamber having a fixed inside perimeter;
an extraction chamber inlet aperture located at said top portion of said extraction chamber;
said extraction chamber inlet aperture is attached with the opposite side of said quick disconnect piping connection terminal of said outlet flexible hose;
a lip of said extraction chamber that maintains a constant shape and perimeter around the perimeter of said top portion of said extraction chamber;
an extraction chamber outlet aperture located at said bottom portion of said extraction chamber;
said extract chamber outlet aperture is attached with the opposite side of said quick disconnect connection terminal of said inlet flexible hose;
an outlet diffuser plate having apertures with a cumulative aperture surface area equal to the surface area of said extraction chamber outlet aperture;
a filtering means; and
an inlet diffuser plate having apertures with a surface area equal to the surface area of said outlet diffuser plate apparatus.

5. A liquid extraction apparatus as claimed in claim 4 wherein said filtering means comprises:
a rigid bottom plate with a plurality of apertures;
a rigid top plate with a plurality of apertures and a protruding vertical stem for easy removal; and
a flexible filter medium between said rigid top plate and said rigid bottom plate that is at least the same size as said inside perimeter of said extraction chamber.

6. A liquid extraction apparatus as claimed in claim 1 wherein said means for holding and storing comprises:
an extract holding chamber having an outlet spout located in the lowest portion of said liquid extract holding chamber;
a self-sealable bottom lip that maintains the same shape as and with a perimeter slightly less than said lip of said extraction chamber whereby when said liquid extract holding chamber is attached to said extraction chamber an air-tight seal is created;
an extract inlet aperture attached with the opposite side of said quick disconnect piping connection terminal of said outlet flexible hose; and
a sealable freshness mechanism.

7. A liquid extraction apparatus as claimed in claim 6 wherein said sealable freshness mechanism is a self-collapsible bladder.

8. A liquid extraction apparatus as claimed in claim 6 wherein said sealable freshness mechanism is a closed cell float that maintains a constant seal against the inside walls of said liquid extract holding chamber.

9. A liquid extraction apparatus as claimed in claim 6 wherein said sealable freshness mechanism is a self-sealing lid to said extraction holding chamber.

10. A liquid extraction apparatus as claimed in claim 1 further comprising a means to attach said means for holding and storing to the underside of a kitchen cabinet.

11. A liquid extraction apparatus as claimed in claim 3 wherein said means of controlling said pump is a timing device.

12. A method of producing liquid extract, comprising the steps of:
maintaining an airtight extraction chamber;
placing a desired amount of granular solid substance within said extraction chamber;
producing a negative pressure environment within said extraction chamber;
circulating a solvent solution within said extraction chamber
whereby producing a soluble solution of extract; and transferring said extract to a holding and storing completed extract.

13. A method as claimed in claim 12 further comprising the step of controlling the amount of time of circulating said solvent solution within said extraction chamber.

14. A method as claimed in claim 12 further comprising the step of providing a pumping means for said solvent solution.
